(19) United States
(12) Patent Application Publication
(10) Pub. No.: US 2016/0225512 A1
(43) Pub. Date: Aug. 4, 2016

(54) POWER INDUCTOR

(71) Applicant: SAMSUNG ELECTRO-MECHANICS CO., LTD., Suwon-Si (KR)

(72) Inventor: Ic Seob KIM, Suwon-Si (KR)

(21) Appl. No.: 14/971,888

(22) Filed: Dec. 16, 2015

(30) Foreign Application Priority Data
Jan. 29, 2015 (KR) 10-2015-0014419

(51) Int. Cl. H01F 27/255; H01F 27/28; H01F 27/29

(52) U.S. Cl. CPC H01F 27/255; H01F 27/292; H01F 27/2823

(57) ABSTRACT

A power inductor includes: a body including a coil support layer, a coil disposed on both surfaces of the coil support layer, a sealing part embedding the coil therein, and a cover part disposed on the sealing part and including a plurality of metal thin plates; and external electrodes disposed on both end surfaces of the body. The plurality of metal thin plates are arranged perpendicularly with respect to an upper surface of the coil.

### CROSS-REFERENCE TO RELATED APPLICATION

This application claims benefit of priority to Korean Patent Application No. 10-2015-0014419 filed on Jan. 29, 2015, with the Korean Intellectual Property Office, the disclosure of which is incorporated herein by reference.

### TECHNICAL FIELD

The present disclosure relates to a power inductor.

### BACKGROUND

An inductor, an important passive element configuring an electronic circuit, together with a resistor and a capacitor, is commonly used as a component removing noise or forming an LC circuit.

The inductor may be classified as a wire-wound inductor, a multilayer inductor, a thin film inductor, or the like, depending on a structure thereof, and has generally been manufactured by stacking, compressing, and sintering a plurality of insulating layers on which coils are formed by printing conductive patterns.

Recently, in information technology (IT) products such as smartphones, and the like, power consumption has increased, and available space for the mounting of passive elements has been reduced. Therefore, demand for miniaturization and high current in direct current (DC)-bias of electronic components required to be mounted in an electronic device has increased.

In order to satisfy the demand for miniaturization and high current, it is advantageous to increase initial saturation magnetization of a magnetic material. Therefore, research into a power inductor using magnetic metal powder having high saturation magnetization has been actively undertaken.

### SUMMARY

An aspect of the present disclosure may provide a power inductor satisfying both miniaturization and high current characteristics.

According to an aspect of the present disclosure, a power inductor having a structure capable of overcoming limitations of existing magnetic metal powder that may not satisfy requirements for use in an inductor, in consideration of high current and miniaturization, may be provided.

To this end, a power inductor includes a metal thin plate bonding structure including a plurality of metal thin plates as a magnetic material for cover parts enclosing a coil.

Here, the plurality of metal thin plates of the metal thin plate bonding structure may be arranged in a direction parallel with respect to a direction of a magnetic field generated by the coil.

In addition, the plurality of metal thin plates may have a rectangular shape or a lattice shape.

### BRIEF DESCRIPTION OF DRAWINGS

The above and other aspects, features and advantages of the present disclosure will be more clearly understood from the following detailed description taken in conjunction with the accompanying drawings, in which:

FIG. 1 is a perspective view of a power inductor according to an exemplary embodiment in the present disclosure;

FIG. 2 is a cross-sectional view taken along line I-I′ of FIG. 1;

FIG. 3 is an exploded perspective view of coils and a coil support layer of FIG. 2;

FIG. 4 is a perspective view illustrating another example of the coil support layer of FIG. 2;

FIG. 5 is a perspective view of an example of a cover part of FIG. 1;

FIG. 6 is a perspective view of another example of a cover part of FIG. 1;

FIG. 7 is a perspective view of another example of the cover part of FIG. 1;

FIG. 8 is a cross-sectional view of a power inductor according to another exemplary embodiment in the present disclosure;

FIG. 9 is an exploded perspective view of coils and a coil support layer of FIG. 8;

FIG. 10 is a perspective view illustrating another example of the coil support layer of FIG. 8;

FIG. 11 is a cross-sectional view of a power inductor in which the cover part of FIG. 7 is used; and

FIG. 12 is a view illustrating a direction of a magnetic field formed in the cover part when a current is applied to the power inductor of FIG. 8.

### DETAILED DESCRIPTION

Hereinafter, embodiments of the present disclosure will be described in detail with reference to the accompanying drawings.

The disclosure may, however, be embodied in many different forms and should not be construed as being limited to the embodiments set forth herein. Rather, these embodiments are provided so that this disclosure will be thorough and complete, and will fully convey the scope of the disclosure to those skilled in the art.

In the drawings, the shapes and dimensions of elements may be exaggerated for clarity, and the same reference numerals will be used throughout to designate the same or like elements.

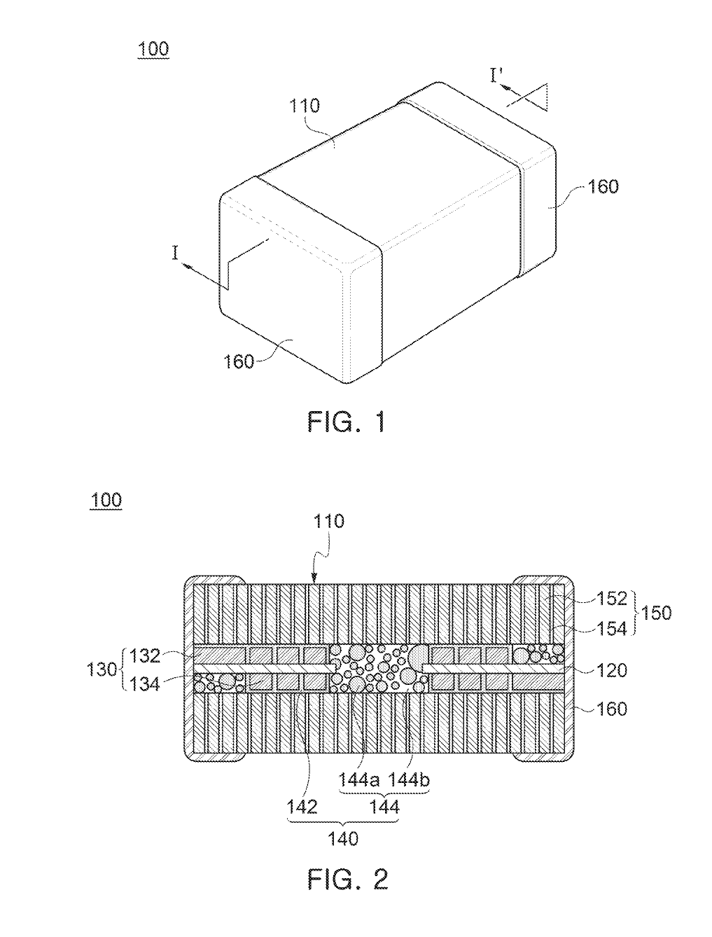

Hereinafter, a power inductor according to exemplary embodiments in the present disclosure will be described with reference to FIGS. 1 through 12.

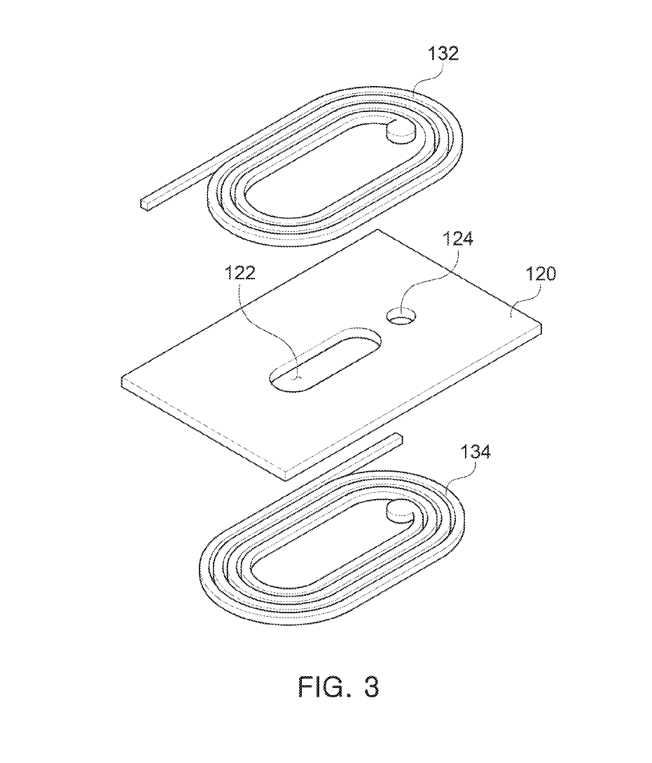

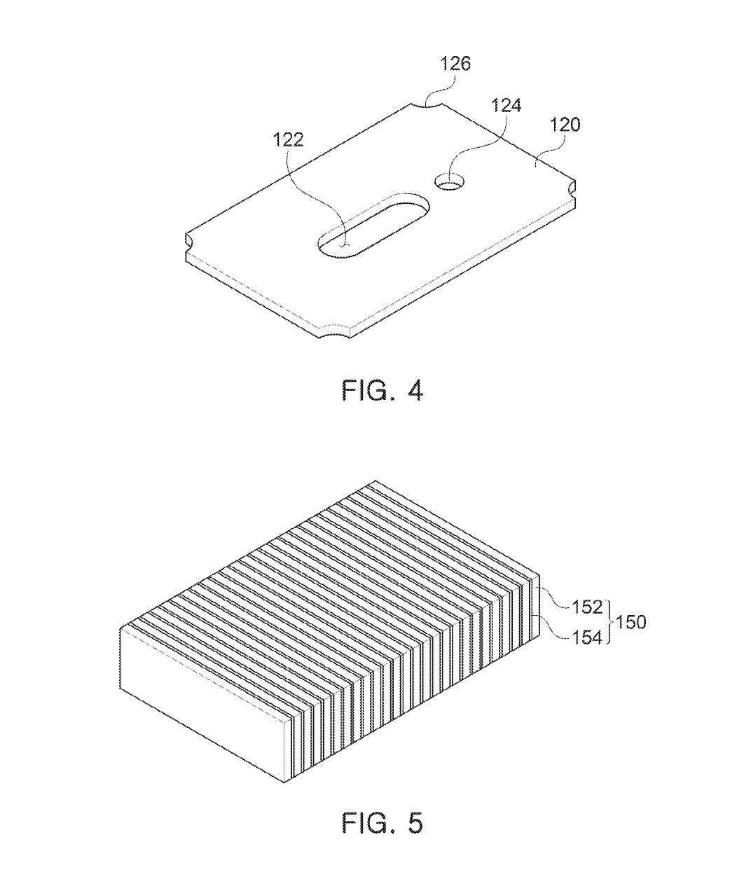

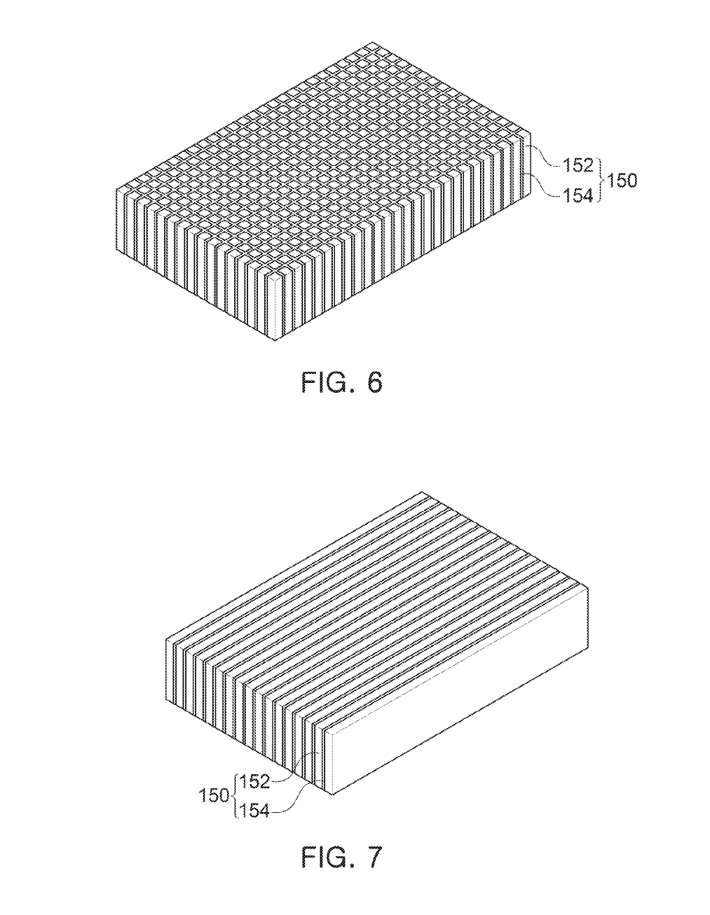

FIG. 1 is a perspective view of a power inductor according to an exemplary embodiment, FIG. 2 is a cross-sectional view taken along line I-I′ of FIG. 1, FIG. 3 is an exploded perspective view of coils and a coil support layer of FIG. 2, FIG. 4 is a perspective view illustrating another example of the coil support layer of FIG. 2, FIG. 5 is a perspective view of an example of a cover part of FIG. 1, FIG. 6 is a perspective view of another example of the cover part of FIG. 1, and FIG. 7 is a perspective view of another example of the cover part of FIG. 1.

As illustrated in FIGS. 1 and 2, a power inductor 100 according to the present exemplary embodiment may mainly include a body 110 including a coil 130 and a cover part 150 covering the coil 130 and external electrodes 160 formed on both end surfaces of the body 110.

In detail, the body 110 may have a rectangular parallelepiped shape, and may include a coil support layer 120, the coil 130 being formed on both surfaces of the coil support layer 120, a sealing part 140 embedding the coil 130 therein, and the cover parts 150 provided as outermost layers of the body 110.

Among the components of the body 110, the coil 130, conductor patterns by which a current is conducted to generate a magnetic field when power is applied thereto, may be wound one or more times in spiral form on both surfaces of the coil support layer 120, as illustrated in FIG. 3.

As illustrated in FIG. 3, the coil 130 may include a first coil 132 formed on one surface of the coil support layer 120 and a second coil 134 formed on the other surface of the coil support layer 120 opposite to one surface of the coil support layer 120.

Here, one end of the first coil 132 may be led out to one end portion of the coil support layer 120, and one end of the second coil 134 may be led out to the other end portion of the coil support layer 120 opposite to one end portion of the coil support layer 120.

In addition, the other ends of the first and second coils 132 and 134 may be positioned to correspond to each other to thereby be electrically connected to each other by a via (not illustrated) formed in the coil support layer 120. Here, the via may be formed by filling a via hole 124 penetrating through the coil support layer 120 in a thickness direction with a conductive material.

Therefore, the first and second coils 132 and 134 stacked on and below the coil support layer, respectively, may be electrically connected to each other by the via.

The first and second coils 132 and 134 and the via configuring the coil 130 may be formed of a material having excellent electrical conductivity, for example, at least one selected from the group consisting of gold (Au), silver (Ag), platinum (Pt), copper (Cu), nickel (Ni), palladium (Pd), aluminum (Al), titanium (Ti), and alloys thereof. However, materials of the first and second coils 132 and 134 and the via are not limited as long as they are general conductive materials.

The first and second coils 132 and 134 may be formed as plating layers on one surface and the other surface of the coil support layer 120, respectively, by plating, advantageous in terms of slimness of the power inductor 100.

The via may be formed by punching or drilling a region of the coil support layer 120 in which the via is to be formed in the thickness direction of the coil support layer 120 to form the via hole 124 and filling the via hole 124 with a conductive material. For example, the via may be formed of a plating layer on which a conductive material is formed by plating or may be formed of a conductive film by filling a through hole with a conductive paste and firing the same.

The coil support layer 120 may be formed of a planar printed circuit board (PCB). However, a material of the coil support layer 120 is not limited thereto, but may be a material commonly known in the art.

As illustrated in FIGS. 3 and 4, the coil support layer 120 may include a through-hole 122 formed in a central portion thereof, disposed in the center of the coil 130 and the via (not illustrated) formed in the via hole 124 corresponding to the other ends of the first and second coils 132 and 134. Referring to FIG. 4, the coil support layer 120 may have chamfers 126 formed at corner portions thereof, and may secure a magnetic path by the through-hole 122 and the chamfers 126.

Meanwhile, although the chamfers 126 are formed in all corners of the coil support layer 120 as illustrated in FIG. 4, the chamfer 126 may be formed at one or more corner portions. Alternatively, the chamfers 126 may be omitted as illustrated in FIG. 3.

As illustrated in FIG. 2, the coil 130 may be embedded by the sealing part 140 provided in the body 110. The sealing part 140 may include an insulating layer 142 and a magnetic composite layer 144.

The insulating layers 142 may enclose surfaces of the first and second coils 132 and 134 so as to prevent short-circuits occurring between conducting wires in each of the first and second coils 132 and 134 and to insulate the first and second coils 132 and 134 and the cover parts 150 from each other.

The insulating layer 142 may be formed of a material having insulating properties, for example, a polymer, or the like. However, a material of the insulating layer 142 is not limited thereto.

The magnetic composite layer 144 may be formed in an empty space between the cover parts 150 formed in upper and lower portions of the body 110, and may enclose the entirety, or portions of, the coil 130 as well as at least a region corresponding to the through-hole 122 (see FIG. 3) of the coil support layer 120. FIG. 2 illustrates that the magnetic composite layer 144 is formed to have a height matching that of the coil 130 coated with the insulating layer 142 to enclose portions of the coil 130.

The magnetic composite layer 144 may be formed of a composite material of a magnetic metal powder 144a and a binder 144b, and may contain spherical magnetic metal powder particles in order to have a high packing factor.

The magnetic metal powder 144a may be formed of a magnetic material, for example, at least one selected from the group consisting of iron (Fe), an iron-nickel (Fe—Ni)-based alloy, an iron-silicon (Fe—Si)-based alloy, an iron-silicon-aluminum (Fe—Si—Al)-based alloy, an iron-chromium-silicon (Fe—Cr—Si)-based alloy, an iron (Fe)-based amorphous alloy, an iron (Fe)-based nanocrystalline alloy, a cobalt (Co)-based amorphous alloy, an iron-cobalt (Fe—Co)-based alloy, an iron-nitrogen (Fe—N)-based alloy, manganese-zinc (Mn—Zn)-based ferrite, and nickel-zinc (Ni—Zn)-based ferrite.

Since the magnetic composite layer 144 containing the magnetic metal powder particles 144a as described above has a high magnetic flux density, the magnetic composite layer 144 may apply a large bias magnetic field to contribute to a high output current of a direct current (DC) to DC converter and generate a significant effect.

In addition, the magnetic composite layer 144 may be formed of a mixture of two or more kinds of magnetic metal powder 144a including coarse particles and fine particles having different average particle sizes. This may allow for an increase in the density of the magnetic metal powder 144a in the magnetic composite layer 144 to increase magnetic permeability.

In this case, as the difference in size between the coarse particles and the fine particles of the magnetic metal powder 144a is increased, the magnetic permeability is improved. However, it may be more advantageous in terms of improvement of the magnetic permeability when an average particle size of the fine particles of the magnetic metal powder 144a is 1.0 μm or more. The reason is that when a surface area of the magnetic metal powder 144a after being bonded to each other is excessively increased due to a decrease in the size of the magnetic metal powder particles, a packing density of the magnetic metal powder particles 144a may not be increased due to the binder 144b bonding the magnetic metal powder particles 144a to each other.

Meanwhile, a material of the binder 144b may be a polymer, such as an epoxy resin, but is not limited thereto.

The magnetic composite layer 144 may be formed by preparing a magnetic paste in which two or more kinds of spherical magnetic metal powder particles 144a having different average particle sizes and the binder 144b such as the epoxy resin, are contained in an organic solvent, applying the magnetic paste to enclose the entirety or portions of the coil 130 as well as the region corresponding to the through-hole 122 (see FIG. 3) of the coil support layer 120, and then hardening the applied magnetic paste.

As illustrated in FIG. 2, the cover parts 150, among components of the body 110, may be formed on the sealing part 140 embedding the coil 130 therein.

The cover parts 150 may be positioned above and below the coil 130 to prevent deteriorations in electrical characteristics of the coil 130.

In the present exemplary embodiment, the cover part 150 may be formed of a metal thin plate bonding structure including a plurality of metal thin plates 152 formed of a magnetic material and bonding members 154 bonding neighboring metal thin plates 152 to each other.

In general, a cover part of an inductor has been formed of a composite material of magnetic metal powder particles and a polymer. The reason is that the magnetic metal powder particles have saturation magnetization greater than that of ferrite to have a high magnetic flux density, thereby satisfying requirements for high current according to the following Equation 1:

$$L = N \frac{φ}{1} = \frac{N \cdot A \cdot B}{1} . \qquad [ Equation 1 ]$$

Here, L is inductance of the inductor, B is magnetic flux density, A is an area through which a magnetic flux passes, N is the number of windings of the coil, and I is an amount of current.

Recently, in order to satisfy requirements for high efficiency, high DC-bias at high current, miniaturization, and the like that have been demanded in a power inductor product group, magnetic permeability of magnetic metal powder needs to be further increased. However, at present a magnetic metal material in a powder state has reached a limit in terms of increasing the magnetic permeability thereof.

The applicant has concluded that bulk metal needs to be used in order to improve the magnetic permeability of the magnetic metal material as a result of a test performed on various materials, material compositions, and the like.

Therefore, in the present disclosure, a magnetic metal material forming the cover part 150 of the power inductor 100 has been changed from an existing powder type into a thin film type divided from the bulk metal, an example and an effect of which will be described in detail below.

As a size of a metal material such as bulk metal is increased, eddy current loss may be increased, and thus, energy efficiency may be decreased and magnetic characteristics may be deteriorated.

In order to solve the above-mentioned problems, the metal thin plates 152 divided from the bulk metal were used in the cover parts 150. In the present exemplary embodiment, a thickness of the metal thin plates 152 is equal to a distance between neighboring metal thin plates 152 in FIG. 5.

The metal thin plate 152 may be formed of at least one selected from the group consisting of a crystalline material, an amorphous material, a nanocrystalline material created in a crystalline structure having a nano size through heat treatment, and the like.

Here, an alloy composition of the metal thin plate 152 may be an alloy of two or more components such as iron-silicon-chromium (Fe—Si—Cr), iron-silicon (Fe—Si), iron-silicon-chromium-boron (Fe—Si—Cr—B), or iron-silicon-boron-phosphorus-copper-niobium (Fe—Si—B—P—Cu—Nb).

Magnetic permeability characteristics and loss characteristics of the amorphous material and the nanocrystalline material may be improved through the heat treatment of the amorphous material and the nanocrystalline material. In a case of performing the heat treatment on the amorphous material and the nanocrystalline material, the amorphous material and the nanocrystalline material may be heat-treated before an adhesive is applied to the metal thin plate 152, and needs to be heat-treated under an inert gas atmosphere in order to prevent oxidation of a metal at the time of being heat-treated.

Particularly, in a case of the nanocrystalline material, it may be confirmed by X-ray diffraction (XRD) analysis that crystal peaks are created through the heat treatment of the nanocrystalline material, and it may be confirmed from an analysis such as a transmission electron microscope (TEM) analysis, that crystal grains having a size of 20 nm or less are created.

The amorphous material may be more advantageous in improvements of magnetic permeability as compared with the crystalline material. However, since low saturation magnetization is formed in the amorphous material due to a decrease in the content of iron (Fe) and an increase in the content of a non-magnetic component for amorphization, the crystalline material of which a content of iron (Fe) is high may have better characteristics in terms of improvements of DC-bias. Therefore, the crystalline material and the amorphous material may be mixed with each other in tuning magnetic permeability and DC-bias, thereby more flexibly coping with improvements of characteristics of a magnetic element.

In consideration of improvements of the DC-bias, only the crystalline material may be used as a material of the metal thin plate 152. In this case, Fe-6.5 wt % Si alloy may be used. The Fe-6.5 wt % Si alloy may have excellent magnetostrictive characteristics to improve loss characteristics of a material. However, when the content of Si is decreased to 6.5 wt % or less, the loss characteristics may be deteriorated, which is undesirable.

In addition, the metal thin plate 152 may be formed to be relatively thin, for example, a thickness of 20 μm or less, in order to improve eddy current loss.

The metal thin plate 152 may be processed in a plate shape from a melt of at least one selected from the group consisting of the crystalline material, the amorphous material, the nanocrystalline material, and the like, having an alloy composition such as Fe—Si—Cr, Fe—Si, Fe—Si—Cr—B, or Fe—Si—B—P—Cu—Nb.

As illustrated in FIG. 5, the metal thin plate 152 may have a rectangular shape. A plurality of metal thin plates 152 having the rectangular shape described above may be bonded to each other by the bonding members 154 to form the cover part 150, the metal thin plate bonding structure.

The bonding member 154 bonding neighboring metal thin plates 152 to each other may be formed of an insulating material, for example, a single organic material or a composite of an inorganic material and an organic material. Here, the organic material may be a thermosetting epoxy resin, enamel, or the like, but is not limited thereto.

In the cover part 150 having the structure illustrated in FIG. 5, as illustrated in FIG. 2, the plurality of metal thin plates 152 may be arranged in a length direction of the body 110. That is, the plurality of metal thin plates 152 may be arranged perpendicularly with respect to an upper surface of the coil 130.

In this case, the metal thin plates 152 may be arranged in a direction parallel with respect to a direction of a magnetic field generated by the coil 130.

As illustrated in FIG. 6, the entire thin plate bonding structure may be formed in a lattice shape by forming one or more cut surfaces in a direction perpendicular to a length direction of the metal thin plates 152 illustrated in FIG. 5, in order to improve additional eddy current loss and improve a quality (Q) factor.

In this case, the metal thin plates 152 each having a block shape may be arranged in both a direction parallel with respect to, and a direction perpendicular with respect to, the direction of the magnetic field generated by the coil 130.

Meanwhile, the bonding members 154, insulating materials, may be filled between the cut surfaces of the metal thin plates 152 having the lattice shape.

Unlike the example of FIG. 5, as illustrated in FIG. 7, the plurality of metal thin plates 152 may be arranged in a width direction of the body 110. Also, in this case, the plurality of metal thin plates 152 may be arranged perpendicularly with respect to the upper surface of the coil 130.

In addition, in FIG. 7, the neighboring metal thin plates 152 may be bonded to each other by the bonding members 154 to form the cover part 150, the metal thin plate bonding structure.

In FIGS. 5 through 7, it may be advantageous, in terms of increasing magnetic permeability and improving DC-bias, that the bonding members 154 are formed to be as thin as possible. Therefore, the bonding members 154 may be formed at a thickness of 5 μm or less. However, in a case in which volumes of the metal thin plates 152 are decreased in the metal thin plate bonding structure due to a design factor, forming the bonding members 154 to have a thickness of 5 μm or more may also be considered.

In addition, a packing factor of the metal thin plates 152 in the cover part 150 may be maintained at a level of 80% or more, preferably, 80 to 95%, in order to improve magnetic permeability and DC-bias through control of the numbers, thicknesses, and the like, of the metal thin plates 152 and the bonding members 154 in the cover part 150.

Here, when the packing factor of the metal thin plates 152 is lower than 80%, the content of magnetic material may be excessively low, and thus, it may be difficult to implement high magnetic permeability and high DC-bias. On the contrary, when the content of the metal thin plates 152 exceeds 95%, adhesion may be decreased, and thus, it may be difficult to maintain a shape of the cover part.

A general thin film power inductor may be formed of a composite of metal powder and a hardening member such as epoxy, such that a packing factor of a metal may be 80% or more at the time of implementing a PI chip. Therefore, even when the metal thin plates are used in the exemplary embodiments, a metal volume needs to be secured so that a packing factor of a metal is 80% or more, similar to that of an existing thin film power inductor, in order to secure a characteristic improvement effect.

Again, referring to FIGS. 1 and 2, a pair of external electrodes 160 among components of the power inductor 100 may be formed on both end surfaces of the body 110.

One of the pair of external electrodes 160 may be connected to the first coil 132 led out to one end portion of the coil support layer 120, and the other of the pair of external electrodes 160 may be connected to the second coil 134 led out to the other end portion of the coil support layer 120. That is, the external electrodes 160 may serve as external terminals electrically connecting the coil 130 and external circuits to each other.

The external electrodes 160 may be formed of a general conductive material, for example, a conductive material selected from the group consisting of gold (Au), silver (Ag), platinum (Pt), copper (Cu), nickel (Ni), palladium (Pd), and alloys thereof.

The external electrodes 160 may be formed by plating the metal to cover both end surfaces of the body 110 using a dipping method, or the like, and sintering the metal at a temperature of about 700° C. to 900° C.

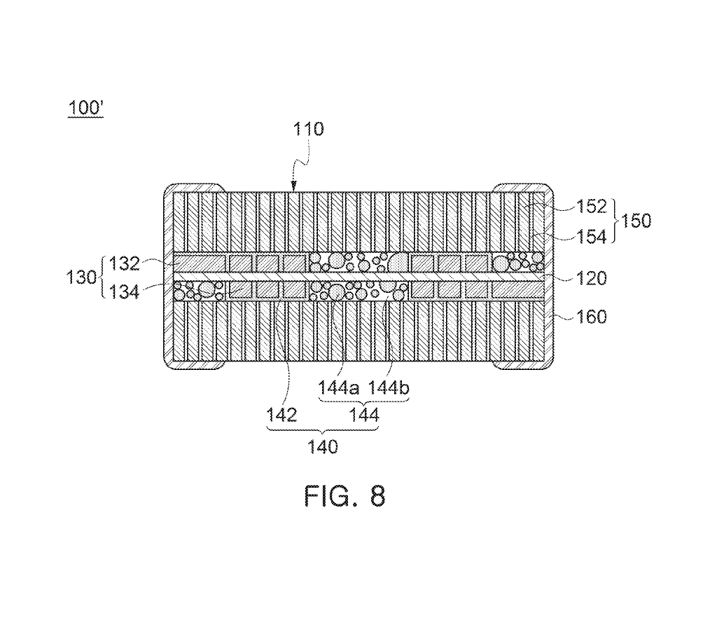

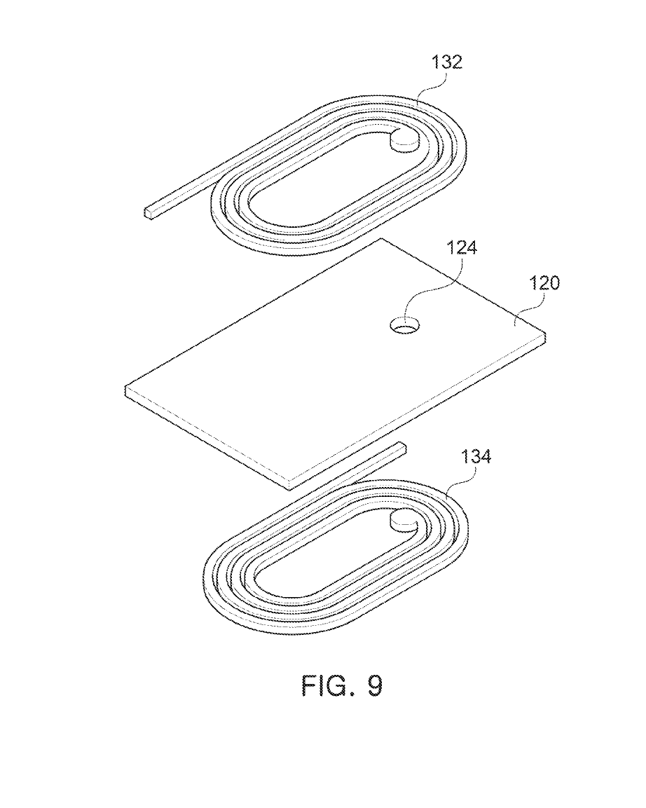

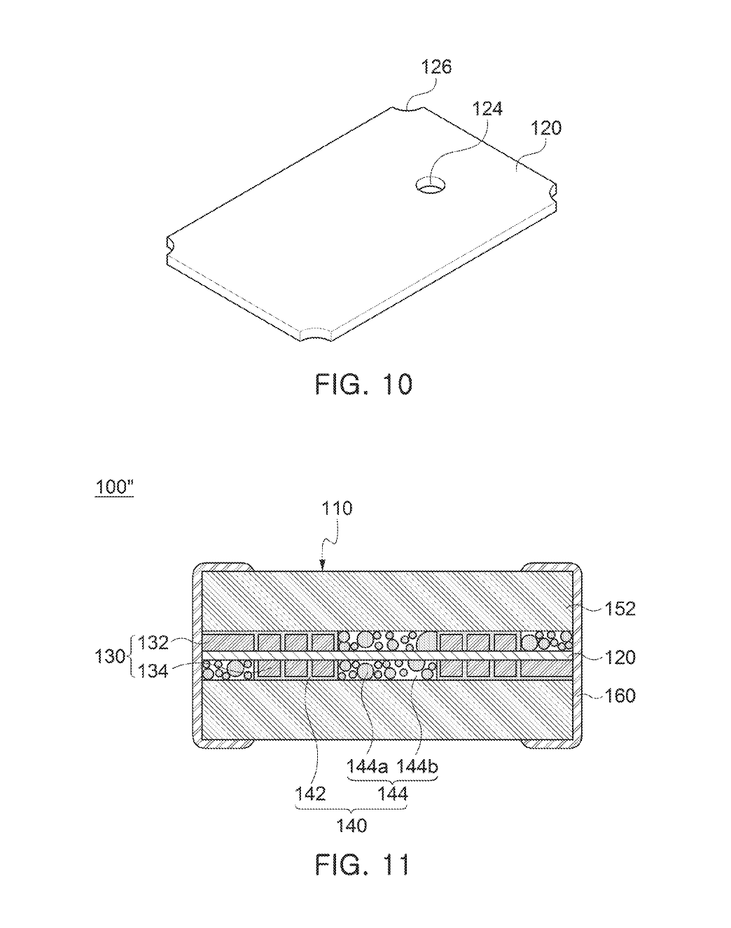

Meanwhile, FIG. 8 is a cross-sectional view of a power inductor according to another exemplary embodiment in the present disclosure, FIG. 9 is an exploded perspective view of coils and a coil support layer of FIG. 8, and FIG. 10 is a perspective view illustrating another example of the coil support layer of FIG. 8.

In the power inductor according to the exemplary embodiment of FIG. 8, components the same as the components of the power inductor according to the exemplary embodiment of FIG. 2 described above will be denoted by the same reference numerals, while overlapped descriptions of the same components will be omitted, and only differences between the power inductor according to the exemplary embodiment of FIG. 8 and the power inductor according to the exemplary embodiment of FIG. 2 will be described.

The power inductor according to the exemplary embodiment illustrated in FIG. 8 may be the same as the power inductor 100 according to the exemplary embodiment illustrated in FIG. 2, except that the through-hole is not formed in the central portion of the coil support layer 120 and a position of the magnetic composite layer 144 is changed since the through-hole is not formed.

As illustrated in FIGS. 8 through 10, in a power inductor 100′ according to another exemplary embodiment, the coil support layer 120 may include a via (not illustrated) formed in the via hole 124 corresponding to the other ends of the first and second coils 132 and 134 and chamfers 126 formed at corner portions thereof, and may secure a magnetic path by the chamfers 126.

Here, the coil support layer 120 may not include the through-hole in the central portion thereof in order to serve as a gap for improving DC-bias.

Alternatively, the chamfer 126 formed in all the corners of the coil support layer 120 in FIG. 10 may be formed in one or more corner portions thereof, and may be omitted as illustrated in FIG. 9.

As described above, in a case in which coil support layer 120 does not include the through-hole in the central portion thereof, the magnetic composite layers 144 may be disposed on and below the coil support layer 120.

Meanwhile, FIG. 11 is a cross-sectional view of a power inductor in which the cover part of FIG. 7 is used.

In the power inductor according to the exemplary embodiment of FIG. 11, components the same as those of the power inductor according to the exemplary embodiment of FIG. 8 described above will be denoted by the same reference numerals, while overlapped descriptions of the same components will be omitted, and only a difference between the power inductor according to the exemplary embodiment of FIG. 11 and the power inductor according to the exemplary embodiment of FIG. 8 will be described.

In a power inductor 100″ according to the exemplary embodiment illustrated in FIG. 11, the cover part 150 illustrated in FIG. 7 may be used. Therefore, the power inductor 100″ according to the exemplary embodiment illustrated in FIG. 11 may be the same as the power inductor 100′ according to the exemplary embodiment illustrated in FIG. 8, except that the thickness of the metal thin plates 152 is arranged in the width direction of the body 110. Also, in a case in which cut surfaces are formed in the length direction of the metal thin plates 152 as described above, additional improvements in loss characteristics may be expected.

In addition, although not illustrated in the drawings, the coil support layer 120 may include the through-hole 122 or the chamfers 126 of FIG. 4 as in the exemplary embodiment of FIG. 2.

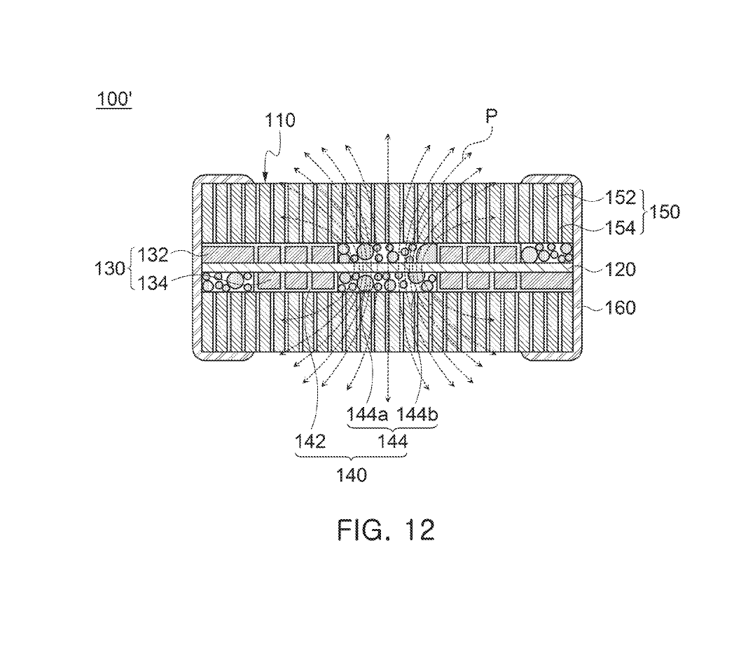

FIG. 12 is a view illustrating a direction of a magnetic field formed in the cover part when a current is applied to the power inductor of FIG. 8.

Due to the above-mentioned configuration, when a current flows in the coil 130 of FIG. 12, the metal thin plates 152 may be positioned to be perpendicular to a direction P of a magnetic field generated by the coil 130, such that free electrons in the metal thin plates 152 may generate a flow of a rotating current by an influence of the magnetic field, to cause eddy current loss.

However, in FIG. 12, a size of a metal may be decreased through the metal thin plates 152 to induce a decrease in eddy current loss, thereby improving loss characteristics.

In the power inductors 100, 100′, and 100″ according to the exemplary embodiments configured as described above, the magnetic metal material having the high saturation magnetization may be used, and a thin plate type bulk metal using shape anisotropy rather than a powder type material may be used to realize an increase in magnetic permeability, thereby satisfying demands for improvements in DC-bias, improvements in DC resistance (Rdc) due to a decrease in the number of turns of coil, and miniaturization of the power inductor.

### 1. Manufacturing of Sample

### Inventive Example

A core manufactured by insulating nanocrystalline-based alloy metal thin plates having a thickness of 20 μm from each other by epoxy and winding copper conducting wires was heat-hardened.

### Comparative Example

Core samples formed of a composite of metal powder and epoxy and having a doughnut shape were molded and manufactured by a compression mold and were then heat-hardened, and copper conducting wires coated with an insulating material were wound ten times with respect to respective core samples.

### 2. Evaluation of Physical Property

Magnetic permeability values (μ′) and loss values (Q=μ′/μ″) of composites according to an Inventive Example and a Comparative Example are illustrated in Table 1. Here, inductance levels of two core samples according to the Inventive Example and the Comparative Example were measured by an E4982A LCR meter to compare magnetic permeability values with each other.

TABLE 1

| | Magnetic | | | | |
|---|---|---|---|---|---|
| | Component | Physical | Frequency Used | | |
| Division | of Core | Properties | 1 MHz | 2 MHz | 3 MHz |
| Comparative | Metal Powder | μ′ | 29.5 | 29.3 | 29.3 |
| Example | | Q = μ′/μ″ | 46 | 54 | 33 |
| Inventive | Metal Thin | μ′ | 680 | 433 | 323 |
| Example | Plate | Q = μ′/μ″ | 1 | 0.8 | 0.8 |

Referring to Table 1, it can be seen that significantly higher magnetic permeability is obtained in a core formed of a metal thin plate according to the Inventive Example than in a core formed of a metal powder according to the Comparative Example.

In addition, since the magnetic permeability of the Inventive Example is twenty times higher than that of the Comparative Example at a frequency of 1 MHz, inductance may be increased in the Inventive Example as compared to the Comparative Example at the same number of turns. Therefore, in the case of the Inventive Example, the number of turns of coil needs to be decreased in order to allow inductance to be matched to a designed inductance. Therefore, Rdc of the coil may be decreased, such that loss characteristics may also be improved.

As set forth above, in a power inductor according to exemplary embodiments, a thin plate type bulk metal using shape anisotropy may be used as a magnetic material of the cover part, thereby satisfying demands for high current in DC-bias, improvement in DC resistance (Rdc) due to a decrease in the number of turns of coil, and miniaturization of the power inductor.

While exemplary embodiments have been shown and described above, it will be apparent to those skilled in the art that modifications and variations could be made without departing from the scope of the present invention as defined by the appended claims.

What is claimed is:

1. A power inductor comprising:
a body including a coil support layer, a coil disposed on both surfaces of the coil support layer, a sealing part embedding the coil therein, and a cover part disposed on the sealing part and including a plurality of metal thin plates; and
external electrodes disposed on both end surfaces of the body,
wherein the plurality of metal thin plates are arranged perpendicularly with respect to an upper surface of the coil.

2. The power inductor of claim 1, wherein the cover part is a metal thin plate bonding structure including the plurality of metal thin plates and bonding members bonding neighboring metal thin plates to each other.

3. The power inductor of claim 2, wherein the metal thin plates are arranged in a length direction or a width direction of the body.

4. The power inductor of claim 2, wherein the bonding members are formed of a single organic material or a composite of an inorganic material and an organic material.

5. The power inductor of claim 1, wherein the metal thin plates are formed of at least one selected from the group consisting of a crystalline material, an amorphous material, and a nanocrystalline material.

6. The power inductor of claim 1, wherein the metal thin plates are formed of any one selected from the group consisting of an iron-silicon-chromium (Fe—Si—Cr) alloy, an iron-silicon (Fe—Si) alloy, an iron-silicon-chromium-boron (Fe—Si—Cr—B) alloy, and an iron-silicon-boron-phosphorus-copper-niobium (Fe—Si—B—P—Cu—Nb) alloy.

7. The power inductor of claim 1, wherein the coil includes:
a first coil disposed on one surface of the coil support layer and having one end led out to one end portion of the coil support layer to thereby be connected to one of the external electrodes; and
a second coil disposed on the other surface of the coil support layer and having one end led out to the other end portion of the coil support layer to thereby be connected to the other of the external electrodes.

8. The power inductor of claim 7, wherein the other end of the first coil and the other end of the second coil are electrically connected to each other by a via provided in the coil support layer.

9. The power inductor of claim 1, wherein the sealing part includes:
an insulating layer enclosing a surface of the coil; and
a magnetic composite layer interposed between upper and lower cover parts included in the cover part, which are disposed in upper and lower portions of the body, respectively, and enclosing the entirety or portions of the coil.

10. The power inductor of claim 9, wherein the magnetic composite layer contains magnetic metal powder and a binder.

11. The power inductor of claim 10, wherein the magnetic metal powder is formed of at least one selected from the group consisting of iron (Fe), an iron-nickel (Fe—Ni)-based alloy, an iron-silicon (Fe—Si)-based alloy, an iron-silicon-aluminum (Fe—Si—Al)-based alloy, an iron-chromium-silicon (Fe—Cr—Si)-based alloy, an iron (Fe)-based amorphous alloy, an iron (Fe)-based nanocrystalline alloy, a cobalt (Co)-based amorphous alloy, an iron-cobalt (Fe—Co)-based alloy, an iron-nitrogen (Fe—N)-based alloy, manganese-zinc (Mn—Zn)-based ferrite, and nickel-zinc (Ni—Zn)-based ferrite.

12. The power inductor of claim 10, wherein the magnetic metal powder contains spherical particles.

13. The power inductor of claim 12, wherein the magnetic composite layer contains two or more kinds of spherical particles having different average particle sizes.

14. The power inductor of claim 1, wherein the coil support layer includes a through-hole in a central portion thereof.

15. The power inductor of claim 1, wherein the coil support layer includes a chamfer in at least one corner portion thereof.

16. A power inductor, comprising:
a body including a coil support layer, a coil disposed on both surfaces of the coil support layer, a sealing part embedding the coil therein, and a cover part disposed on the sealing part and including a plurality of metal blocks arranged in an array; and
external electrodes disposed on both end surfaces of the body.

17. The power inductor of claim 16, wherein the cover part further includes bonding members bonding neighboring metal blocks to each other.

18. The power inductor of claim 16, wherein the metal blocks are formed of at least one selected from the group consisting of a crystalline material, an amorphous material, and a nanocrystalline material.

19. The power inductor of claim 16, wherein the metal blocks are formed of any one selected from the group consisting of an iron-silicon-chromium (Fe—Si—Cr) alloy, an iron-silicon (Fe—Si) alloy, an iron-silicon-chromium-boron (Fe—Si—Cr—B) alloy, and an iron-silicon-boron-phosphorus-copper-niobium (Fe—Si—B—P—Cu—Nb) alloy.
